(19) United States
(12) Patent Application Publication
(10) Pub. No.: US 2011/0022427 A1
(43) Pub. Date: Jan. 27, 2011

(54) System and Method for Determining and Reserving Available Parking

(76) Inventor: Medwin Dayan, Highland Park, IL (US)

Correspondence Address: UNGARETTI & HARRIS LLP;INTELLECTUAL PROPERTY GROUP - PATENTS, 70 WEST MADISON STREET, SUITE 3500, CHICAGO, IL, 60602-4224, US

(21) Appl. No.: 12/842,181

(22) Filed: Jul. 23, 2010

Related U.S. Application Data
(60) Provisional application No. 61/227,928, filed on Jul. 23, 2009.

(51) Int. Cl. G06Q 10/00; G06F 17/00; G01C 21/26; G06Q 30/00; H04W 4/04

(52) U.S. Cl. 705/5; 701/300; 701/208; 455/456.3

(57) ABSTRACT

A system and method for locating and reserving parking spaces at a desired location is provided. The system and method can be implemented by a phone application or other software using a GPS device in or otherwise coupled to the application.

### CROSS-REFERENCE TO RELATED APPLICATIONS

The present application claims the benefit of U.S. Provisional Patent Application No. 61/227,928 filed Jul. 23, 2009, the contents of which are incorporated herein by reference.

### FEDERALLY SPONSORED RESEARCH OR DEVELOPMENT

N/A

### FIELD OF THE INVENTION

The present invention generally relates to an application for use on a phone or other personal computing device for determining the location of available parking and other related information in a geographical area, and enabling a user to reserve a parking spot.

### BACKGROUND OF THE INVENTION

A variety of applications are available for phones—such as the Apple iPhone—or other personal computing devices (e.g., laptops, etc.). Many of these applications utilize the GPS functionality of the phone or computing device (when available).

The present invention provides an application to facilitate locating and reserving a parking space at a desired location.

### SUMMARY OF THE INVENTION

The present invention is a system and method for providing real-time information on the availability of parking spaces, parking prices and other related information regarding the parking space (e.g., identification of whether the parking is metered?, enclosed? are valet services provided? etc.) at parking facilities located near a user's location, or at a desired location. The system and method also provides interactive features to facilitate various forms of reservations for parking at a select parking facility. This includes providing the ability for the owners and/or operators of a parking facility to modify and disseminate in real-time, based on occupancy rates and other factors, the availability and pricing of parking spaces.

The system and method are implemented via a software application on a smart phone or other similar mobile computing device (this can include a GPS system installed or utilized in a vehicle) in communication with one or more servers or computers. This can be accomplished over the Internet, or other suitable network or communication medium. The servers can be maintained by the various parking facilities and can communicate directly with the user's computing device, or via a host computer maintained by an entity servicing the application. The mobile computing device can include a touch screen or mouse, and can be navigated in a conventional manner.

The system and method can be used within the vicinity of a user's geographic location based on a GPS signal or other methods of location. The system and method can take advantage of, but are not limited to, industry standard internet browsers, GPS devices and software applications custom built for smart phones such as, for example, the Apple iPhone, BlackBerry Storm, Palm Pre and Google Android.

The invention is also provided to allow the owners and/or operators of parking facilities to influence occupancy rates by adjusting and marketing available parking information and discounted parking rates in real-time to potential customers. It accomplishes this by allowing parking facilities to market to potential customers who are using the present application to easily determine their preferred parking options based on available parking and pricing information around their current or future location.

In accordance with one embodiment, the present invention provides parking facility owners and/or operators with an internet based system that allows the facility to market in real-time the availability of parking spaces and modify parking rates for a variety of time periods. The information is subsequently disseminated when a potential customer uses one of a variety of software applications using GPS tracking information provided by the customer's smart phone or GPS device. Alternatively, the customer may access a website via an industry standard browser to access similar parking information and reservation tools.

Based on parking availability and rate information from a variety of sources including the information input by parking facility owners/operators, the system determines and displays various options for parking around the user's current or future location. The future location can be inputted into the application. The system and method can emphasize or highlight the preferred and/or most cost effective options. Once a customer has decided where they prefer to park, the system can allow the customer to make reservations for parking at standard or discounted parking rates via a variety of methods including electronic reservations via the software application, industry standard internet browsers or verbally over the phone.

In operation according to one preferred embodiment, a user can initiate a parking software application on the user's phone or other handheld computing device capable of connecting to the Internet or other available network. The application queries or otherwise receives or obtains parking information from parking facilities in the desired area based on the user's present location or on a location inputted by the user. The parking information can be supplied by each parking facility over the Internet or other network. Additionally, it is contemplated that parking meters (i.e., street parking) can be connected to the Internet or other network to provide information regarding availability, hours of enforcement, cost/time, etc.

Preferably, the application is coupled to a GPS device to facilitate identification of the parking facilities in the desired location. The GPS device can be included in the phone or computing device, or can be a separate unit coupled to the phone or computing device. The application can also be included in a GPS system installed in a car or other vehicle.

The application can provide links directly to identified parking facilities having available space. This enables the user to communicate directly with a parking facility to reserve a space at a specified time.

In accordance with yet another embodiment of the invention, the parking application can be configured to include functionality for a reverse auction and/or name-your-price transaction. Each can be enacted by the user by clicking on an appropriate labeled button or tab in the application. The reverse auction provides a message to garages in the user's vicinity (or a desired location entered by the user) to bid on the user's patronage. The user can select one of the bids received, and can transmit payment information to reserve the parking spot. Similarly, the user can select a name-your-price option and enter a desire price or price range. This information is sent to garages in the user's vicinity (or a desired location entered by the user). A garage accepting the price can then send a message back to the user. The user can then confirm with one of the responding garages agreeing to the price. Again, payment information can then be transferred to the selected garage to reserve the parking spot.

Other features and advantages of the invention will be apparent from the following specification including the drawings.

### BRIEF DESCRIPTION OF THE FIGURES

To understand the present invention, it will now be described by way of example, with reference to the accompanying drawings in which:

FIG. 1 is a plan view of a phone including a parking application in accordance with the present invention;

FIG. 2 is a plan view of the phone with the application opened showing a home or initial page of the application; and,

FIG. 3 is a flow chart showing functional aspects of the application

### DETAILED DESCRIPTION OF THE INVENTION

While this invention is susceptible of embodiments in many different forms, there is shown in the Figures and will herein be described in detail preferred embodiments of the invention with the understanding that the present disclosure is to be considered as an exemplification of the principles of the invention and is not intended to limit the broad aspect of the invention to the embodiments illustrated.

The present invention provides a system for locating parking spaces at a desired location, and for reserving a space at a selected parking facility (e.g., a parking garage). The system can also allow owners or operators of parking facilities to market and update information relating to availability of parking spaces, and provide discounted rates to users of the system. The parking system is particularly of importance in dense urban areas, such as downtown Chicago, which have limited parking available. The system preferably works in real time on the most updated information available.

The system includes a software application residing on a phone or other computing device having sufficient functionality (e.g., processing power) to run the application. The phone or computing device preferably includes a communication platform for access to the Internet or other suitable network. The connection to the Internet or other suitable network can be wireless.

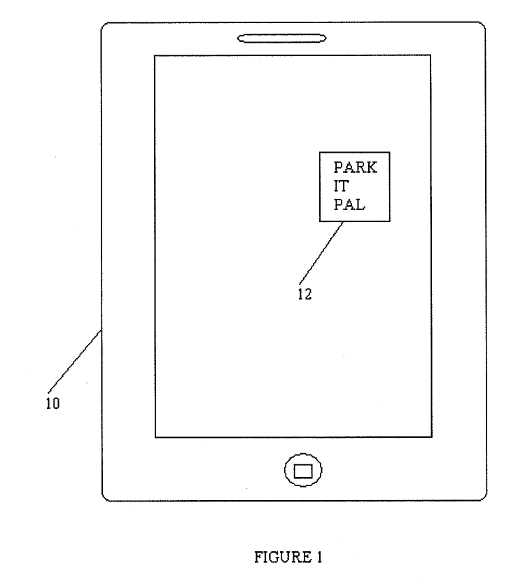

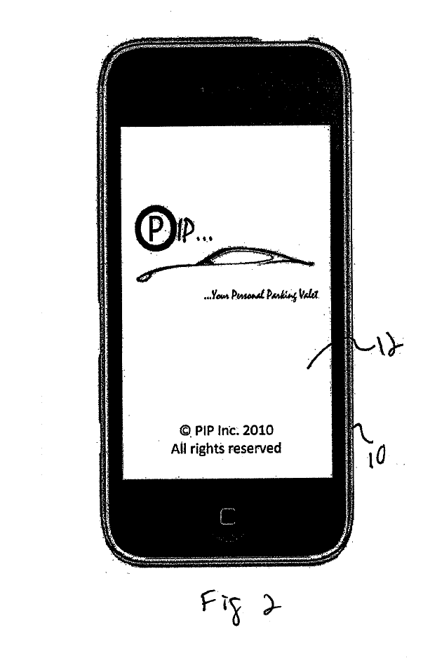

Referring to FIGS. 1 and 2, a phone 10 with a touch screen is provided with a parking application 12. Opening the parking application 12 allows the user to select a location or area (or indicate use of the current location) and search for available parking in the selected area. The parking application 12 can utilize any GPS capabilities of the phone 10 to locate parking facilities in the desired location and display the facilities on a map generated on a screen of the phone 10. The application 12 can also utilize the computing device's GPS to indicate the current location if selected.

Each parking facility preferably includes a server available over the Internet or other suitable network with updated information regarding parking at that facility. The information can include, for example, the number of spaces available, the current rate (including any discounts offered), whether valet services are provided, whether the parking is enclosed, semi-enclosed or exposed, etc. In this regard, the facility server can host a website with the desired information, or otherwise be configured to communicate with the application 12 on the user's phone or other computing device to provide the information. Alternatively, the system can be set up so that each facility can provide the information to a computer system of an entity servicing the parking application, which can send the information to the user's of the parking application. In either case, the information is communicated to the user and can be displayed on the phone's or other computing device's screen.

When available at one or more facilities, the parking application can include a feature to enable the user to reserve a parking space at a desired location at a desired time. The parking application can communicate with the parking facility server, or go through the computer system of the entity servicing the parking application, to make the reservations. In this regard, the parking application can relay credit card information to the parking facility to lock in and reserve a parking space at a desired time. The parking facility can be set up so that the credit card utilized will enable the user to enter the parking facility via the facility's gate system. The reservation secured by the credit card through the parking application will include any discounts provided by the facility.

The system can also be used by the parking facility to advertise available space, as well as any parking discounts. In this manner, the parking facility can monitor its occupancy rate and provide incentives to users of the parking application if there are a significant number of vacant spaces.

The application can be configured to highlight a preferred parking location based on a variety of user input criteria. Such criteria can include, for example, price, anticipated duration, location, etc.

In addition to the functionality described, the application 12 can be configured to have a reverse auction or bid system. In this set up, the application 12 can allow a user to enter a location or area, and request parking facilities in that area to bid for the user's reservation. In this regard, the user can enter a proximity value (e.g., within X blocks or miles) to the location that is acceptable. The facilities can then provide the user with a parking rate (typically a discounted rate) to obtain the user's patronage of the facility. The user can then select one of the bids received.

In an alternative embodiment, a user can provide a desired rate and request the facilities in the vicinity of the entered location to meet or accept that rate (or reject—e.g., by not responding). The user can then select from the facilities that accepted the desired rate.

Once the user selects a facility, the application 12 transfers credit or debit card information, or utilizes a service such as Paypal, to the accepted parking facility to lock-in the reservation. Known encryption techniques and/or other security measures can be implemented to assure confidentiality of the user's information.

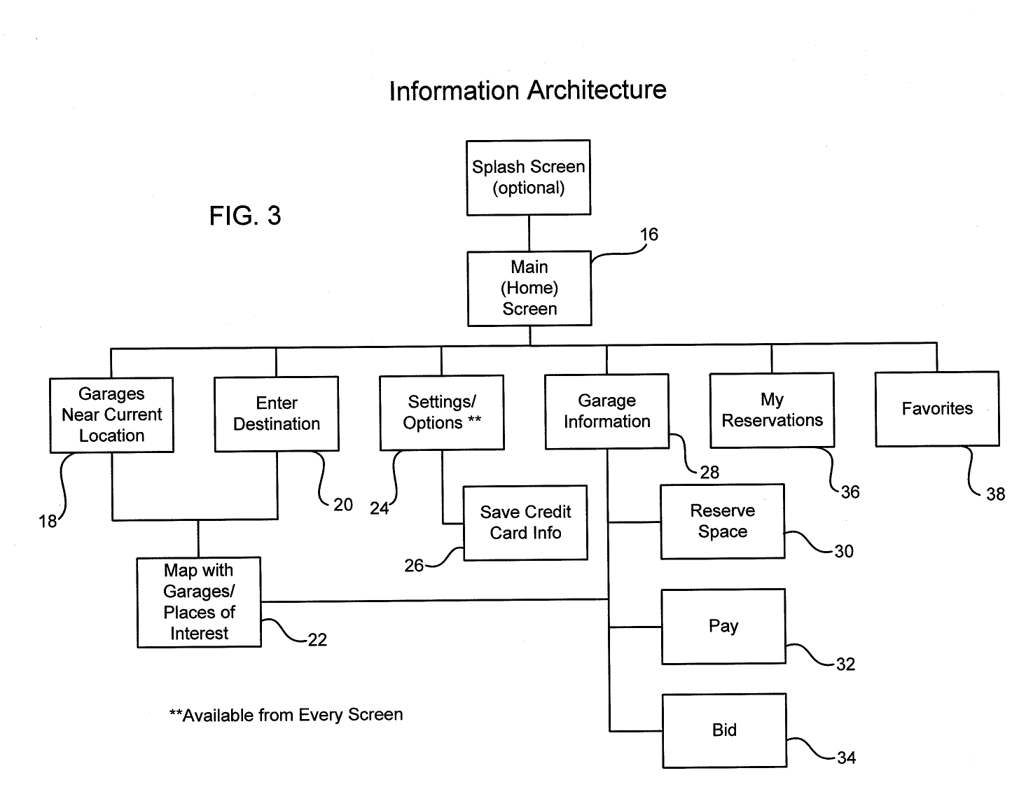

FIG. 3 shows a flow chart identifying some of the functionality of the application. Initially, the user is directed to a main or home screen 16 upon activation of the application 12. This screen will allow the user to locate facilities at the user's current location 18 or enable the user to enter a destination location 20. The application 12 can be configured to allow the user to enter a desired time or date that the user would like the parking spot. Under either approach, the application will generate a map 22 identifying parking facilities proximate the indicated location. The parking facilities can appear as “pins” on the generated map. Other icons could also be used to display the facilities (e.g., a figure, or a “P,” etc.). The pins or icons can be color coded to reflect an aspect of the facility (e.g., green=discounted rates, red=within X miles of location, blue=enclosed, etc.). The map can be expanded or contracted in a conventional manner as desired by the user. The map 22 can also show other places of interest near the designated location.

The application 12 can allow the user to select desired settings or options 24 for configuring the application 12 (this can include items, such as allowing advertisements to be shown or not shown, map types/sizes, etc.). The settings can also allow the user to input credit or debit card information 26, or provide a link to Paypal or another third party service for implementing payment of any reserved parking spots.

The application 12 also allows the user to obtain information relating to a selected facility 28, and to interact with the facility 30, 32, 34. Clicking on or otherwise selecting a pin or icon can call up information relating to the facility (e.g., rates, address, phone number, etc.).

The application 12 is interactive between the user and parking facility. The user can reserve a space at a selected facility at an indicated rate 30 through the application (i.e., buttons or other icons can be provided to allow the user to transmit to the facility a request for or confirmation of a reservation). It can also utilize the application 12 to pay for the space 32 with the credit/debit card information, or enable the third party provider to make payment.

The application 12 can allow a user to select a request for a bid 34. This transmits a request to facilities in a designated area to respond with discounted rates to the user. The user can then choose which bid to accept and reserve a spot with the chosen facility.

The application 12 can store reservations 36, and provide reminders to the user. The application 12 can also store a list of favorite parking facilities 38. These can be arranged in any manner, such as those proximate select locations.

In accordance with another embodiment of the invention, the application 12 can be configured to communicate with parking meters. The parking meters can be outfitted with communication devices for communicating data over the Internet. Such data can include rates and availability.

While the specific embodiments have been illustrated and described, numerous modifications come to mind without significantly departing from the spirit of the invention and the scope of protection is only limited by the scope of the accompanying Claims.

I claim:

1. A system for locating parking systems comprising:
a computing device having an application configured to identify locations of parking facilities proximate a designated location and display the parking facilities locations on a map, and further configured to provide a link for each displayed parking facility for displaying rate information for parking at a selected displayed parking facility.

2. The system of claim 1 wherein the computing device is a mobile device.

3. The system of claim 2 wherein the mobile device is a cellular phone.

4. The system of claim 2 wherein the mobile device includes a global positioning system, and wherein the designated location is the location of the mobile device determined from the global positioning system.

5. The system of claim 1 wherein the designation location is entered into the computing device by a user.

6. The system of claim 2 wherein the application is further configured to allow a user of the mobile device to communicate with a selected parking garage to reserve a parking space.

7. The system of claim 6 wherein the mobile device is configured to receive parking information from parking facilities proximate the designated location indicative of a discounted parking rate.

8. The system of claim 1 wherein the application is configured to transmit credit or debit card payment information to a selected facility to reserve a parking spot.

9. The system of claim 1 wherein the application is configured to transmit bid requests to parking facilities proximate the designated location and receive responses from the parking facilities indicative of an offered parking rate.

10. A system for locating and reserving a parking space comprising:
a mobile computing device configured to electronically search for and identify parking facilities having available parking spaces proximate a designated location over a network connection in real time, the computing device configured to interact with a select parking facility identified in the search to enable a user of the mobile computing device to electronically reserve a parking space at the select parking facility.

11. The system of claim 10 further comprising a GPS device coupled to the mobile computing device to facilitate location of the parking facilities having available parking spaces.

12. The system of claim 10 wherein the mobile computing device is a cellular phone having an application configured to receive an inputted location and to electronically obtain available parking information from a parking application host computing device.

13. The system of claim 10 further comprising a host computing device in communication with parking facility servers of the identified parking facilities, the host computing device configured to receive parking information from the parking facility servers and provide the information to the user computing device.

14. The system of claim 10 wherein the mobile computing device is configured to transmit a signal directly to a parking facility server over a wireless network.

15. The system of claim 10 wherein the mobile computing device is configured to transmit a bid request to identified parking facilities requesting each parking facility to provide a bid rate for reserving a parking space.

16. The system of claim 15 wherein the mobile computing device is configured to receive bid responses from the identified parking facilities.

17. The system of claim 16 wherein the mobile computing device is configured to transmit an acceptance to a select one parking facility of the responding identified parking facilities, the acceptance including user payment information for reserving a space at the one parking facility.

18. The system of claim 10 wherein the mobile computing device is configured to receive an inputted acceptable user rate and transmit a request for acceptance for reserving a parking space at the acceptable user rate to the identified parking facilities.

19. The system of claim 18 wherein the mobile computing device is configured to receive an acceptance from one parking facility of the identified parking facilities.

20. The system of claim 19 wherein the mobile computing device is configured to transmit payment information to the one parking facility.
